(19) United States
(12) Patent Application Publication
(10) Pub. No.: US 2025/0298344 A1
(43) Pub. Date: Sep. 25, 2025

(54) BELT DEVICE AND IMAGE FORMING APPARATUS INCORPORATING SAME

(71) Applicant: Hiroki MATSUURA, Kanagawa (JP)

(72) Inventor: Hiroki MATSUURA, Kanagawa (JP)

(73) Assignee: Ricoh Company, Ltd., Tokyo (JP)

(21) Appl. No.: 19/069,580

(22) Filed: Mar. 4, 2025

(30) Foreign Application Priority Data
Mar. 20, 2024 (JP) 2024-044301

(51) Int. Cl. G03G 15/16; G03G 15/01

(52) U.S. Cl. CPC G03G 15/1615; G03G 15/0131; G03G 15/0189; G03G 15/162

(57) ABSTRACT

A belt device includes a plurality of rollers, a belt, a correction mechanism, a holder, and a restricting member. The belt is stretched and supported by the plurality of rollers. The correction mechanism inclines one roller of the plurality of rollers in conjunction with movement of the belt in a width direction of the belt. The holder holds a shaft of the one roller to be rotatable. The restricting member is disposed on the shaft outside the holder in the width direction to be indirectly or directly contactable with the holder to restrict movement of the one roller in the width direction. The restricting member is fixed to the shaft and is rotatable with the one roller together.

### CROSS-REFERENCE TO RELATED APPLICATION

This patent application is based on and claims priority pursuant to 35 U.S.C. § 119 (a) to Japanese Patent Application No. 2024-044301, filed on Mar. 20, 2024, in the Japan Patent Office, the entire disclosure of which is hereby incorporated by reference herein.

### BACKGROUND

### Technical Field

Embodiments of the present disclosure relate to a belt device including a belt that travels in a specified direction, and an image forming apparatus, such as a copier, a printer, a facsimile machine, or a multifunction peripheral (MFP) having at least two of such capabilities, incorporating the belt device.

### Related Art

A belt device in an image forming apparatus has been proposed in which a correction mechanism that corrects a belt deviation of a belt such as an intermediate transfer belt is installed. The correction mechanism inclines one of a plurality of rollers that stretch and support the belt, in conjunction with the movement of the belt in the width direction (belt deviation), to move the belt in the opposite direction. On the other hand, a technique has also been proposed in which a restricting member such as an E-ring that restricts the movement of a roller in the width direction inclined by the correction mechanism is installed on a shaft of the roller via an intermediate member on the outside in the width direction with respect to a supporter that supports the roller to be rotatable.

### SUMMARY

In an embodiment of the present disclosure, a belt device includes a plurality of rollers, a belt, a correction mechanism, a holder, and a restricting member. The belt is stretched and supported by the plurality of rollers. The correction mechanism inclines one roller of the plurality of rollers in conjunction with movement of the belt in a width direction of the belt. The holder holds a shaft of the one roller to be rotatable. The restricting member is disposed on the shaft outside the holder in the width direction to be indirectly or directly contactable with the holder to restrict movement of the one roller in the width direction. The restricting member is fixed to the shaft and is rotatable with the one roller together.

In another embodiment of the present disclosure, an image forming apparatus includes the belt device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view of a configuration of an image forming apparatus according to an embodiment of the present disclosure;

FIG. 2 is an enlarged view of a part of an image forming device in the image forming apparatus of FIG. 1;

FIG. 3 is a schematic view of an intermediate-transfer-belt device and components around the intermediate transfer belt device;

FIG. 4 is a cross-sectional view of one end in a width direction of an intermediate transfer belt and a correction roller;

FIG. 5 is a schematic view of a part of an intermediate-transfer-belt device;

FIGS. 6A and 6B are cross-sectional views of an intermediate transfer belt, illustrating an operation of correcting belt deviation;

FIGS. 7A and 7B are diagrams illustrating a mechanism for correcting belt deviation of an intermediate transfer belt;

FIG. 8 is a top view of an intermediate-transfer-belt device;

FIG. 9 is a cross-sectional view of an intermediate transfer belt and a correction roller over the entire area in the width direction;

FIG. 10 is a cross-sectional view of one end in a width direction of an intermediate transfer belt and a correction roller as a comparative example;

FIG. 11 is a cross-sectional view of one end in a width direction of an intermediate transfer belt and a correction roller as a first modification; and

FIG. 12 is a cross-sectional view of one end in a width direction of an intermediate transfer belt and a correction roller as a second modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. Like reference signs are assigned to like elements or components and descriptions of those elements or components may be simplified or omitted. As used herein, the singular forms “a,” “an,” and “the” are intended to include the plural forms as well, unless the context clearly indicates otherwise.

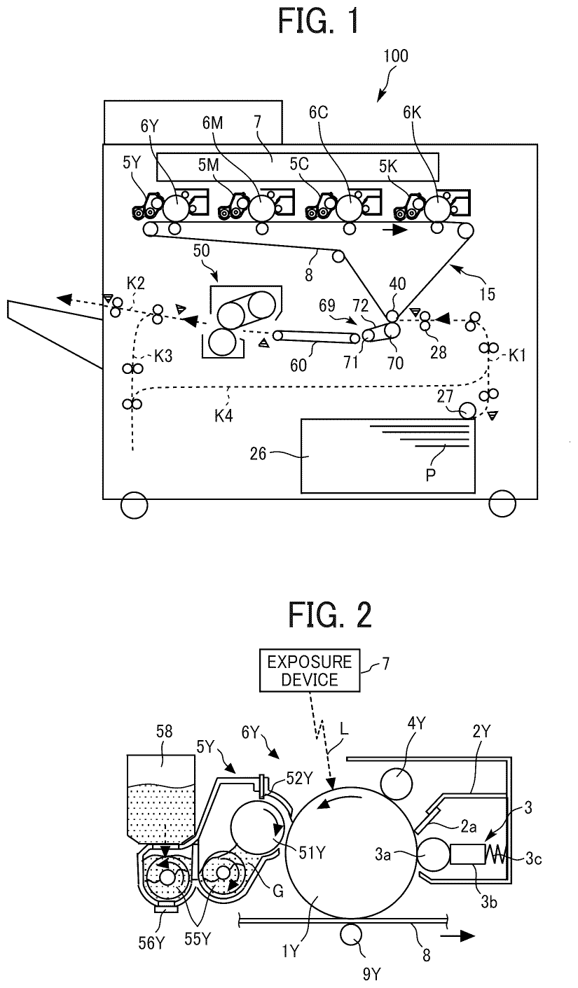

With reference to FIGS. 1 and 2, a description is given of the overall configuration and operation of an image forming apparatus 100 according to an embodiment of the present disclosure. FIG. 1 is a schematic view of a printer as the image forming apparatus 100, and FIG. 2 is an enlarged view of a part of an image forming device in the printer. As illustrated in FIG. 1, an intermediate-transfer-belt device 15 as a belt device is disposed in the middle of a body of the image forming apparatus 100. The image forming apparatus 100 includes image forming devices 6Y, 6M, 6C and 6K corresponding to the colors of yellow, magenta, cyan, and black. The image forming devices 6Y, 6M, 6C and 6K are arranged in parallel to face an intermediate transfer belt 8 of the intermediate-transfer-belt device 15. A secondary-transfer-belt device 69 is disposed below the intermediate-transfer-belt device 15.

With reference to FIG. 2, the image forming device 6Y for yellow includes a photoconductor drum 1Y, and further includes a charging device 4Y, a developing device 5Y, a cleaning device 2Y, a lubricant applicator 3, and a charge eliminator, which are disposed around the photoconductor drum 1Y. A series of image forming processes including charging, exposure, developing, primary transfer, cleaning, and charge elimination processes is performed on the photoconductor drum 1Y. Accordingly, a yellow image is formed on the surface of the photoconductor drum 1Y.

The other three image forming devices 6M, 6C, and 6K have substantially the same configuration as that of the image forming device 6Y for yellow except for the color of toner used therein and form magenta, cyan, and black toner images, respectively. Only the image forming device 6Y is described below and descriptions of the other three image forming devices 6M, 6C, and 6K are appropriately omitted.

With reference to FIG. 2, the photoconductor drum 1Y is rotated counterclockwise by a main motor. The charging device 4Y uniformly charges the surface of the photoconductor drum 1Y (charging process). Then, the charged surface of the photoconductor drum 1Y reaches a position where an exposure device 7 irradiates the surface of the photoconductor drum 1Y with a laser beam L, and the photoconductor drum 1Y is scanned with the laser beam L in a width direction at the position, thereby forming an electrostatic latent image for yellow on the surface of the photoconductor drum 1Y (exposure process). The width direction is a main scanning direction perpendicular to the surface of the plane on which FIGS. 1 and 2 are illustrated.

The surface of the photoconductor drum 1Y bearing the electrostatic latent image reaches a position opposite the developing device 5Y, and the electrostatic latent image is developed into a toner image of yellow at the position (development process). When the surface of the photoconductor drum 1Y bearing the toner image reaches a position opposite (facing) a primary transfer roller 9Y via the intermediate transfer belt 8, the toner image on the surface of the photoconductor drum 1Y is transferred onto the surface of the intermediate transfer belt 8 at the position (primary transfer process). After the primary transfer process, a certain amount of residual toner (untransferred toner) remains on the photoconductor drum 1Y.

When the surface of the photoconductor drum 1Y reaches a position opposite the cleaning device 2Y, a cleaning blade 2a collects the residual toner (untransferred toner) from the photoconductor drum 1Y into the cleaning device 2Y (cleaning process). The cleaning device 2Y includes a lubricant supply device 3 (a lubricant supplying device for the photoconductor drum 1Y). The lubricant supply device 3 includes a lubricant supply roller 3a, a solid lubricant 3b, and a compression spring 3c. The lubricant supply roller 3a rotating clockwise in FIG. 2 scrapes a small amount of lubricant from the solid lubricant 3b and applies the lubricant to the surface of the photoconductor drum 1Y. Subsequently, the surface of the photoconductor drum 1Y reaches a position opposite the charge eliminator. The charge eliminator removes residual potentials from the photoconductor drum 1Y at this position. Thus, a series of image forming processes executed on the surface of the photoconductor drum 1Y is completed.

The other image forming devices 6M, 6C, and 6K perform the series of image forming processes described above in substantially the same manner as the image forming device 6Y for yellow. In other words, the exposure device 7 disposed above the image forming devices 6M, 6C, and 6K irradiates photoconductor drums 1M, 1C, and 1K of the image forming devices 6M, 6C, and 6K with the laser beams L based on image data. Specifically, the exposure device 7 includes a light source to emit the laser beams L, multiple optical elements, and a polygon mirror rotated by a motor. The exposure device 7 scans, with the laser beams L, the photoconductor drums 1M, 1C, and 1K via the multiple optical elements while deflecting the laser beams L with the polygon mirror. Note that a plurality of light emitting diodes (LEDs) may be arranged side by side in the width direction as the exposure device 7. Then, the toner images formed on the photoconductor drums 1M, 1C, and 1K through the development process of the developing devices 5M, 5C, and 5K are primarily transferred therefrom and superimposed onto the intermediate transfer belt 8. Thus, a color toner image is formed on the intermediate transfer belt 8.

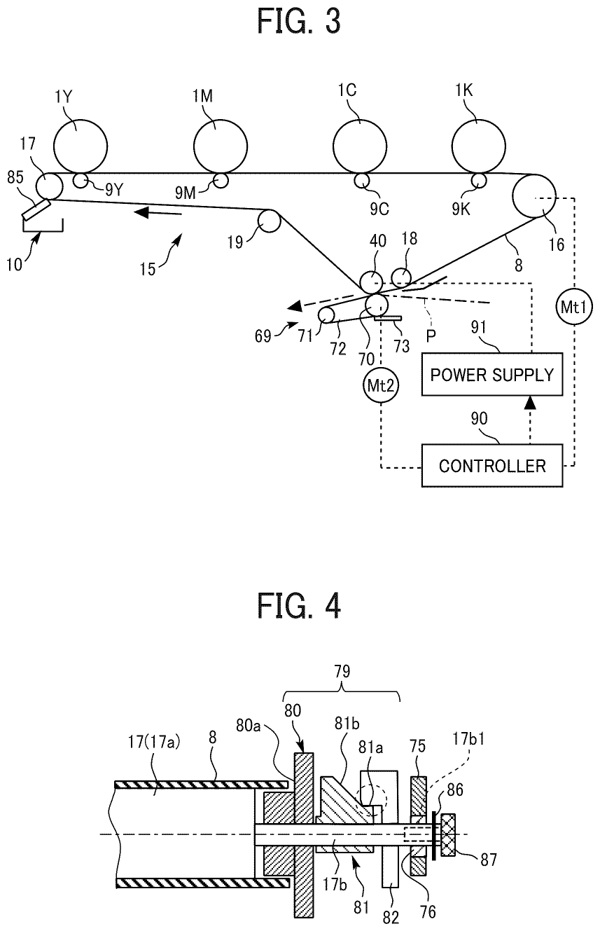

The intermediate transfer belt 8 is stretched around and supported by a plurality of rollers 16, 17, 18, 19, and 40, and is rotated in the direction indicated by an arrow in FIG. 3 by a rotational drive of a drive roller 16, which is one of the plurality of rollers, driven by a drive motor Mt1. The four primary transfer rollers 9Y, 9M, 9C, and 9K are pressed against the corresponding photoconductor drums 1Y, 1M, 1C, and 1K, respectively, via the intermediate transfer belt 8 to form primary transfer nips. A transfer voltage (primary transfer bias) opposite in polarity to toner is applied to the primary transfer rollers 9Y, 9M, 9C, and 9K. The intermediate transfer belt 8 travels in the direction (clockwise) indicated by an arrow in FIG. 3 and sequentially passes through the primary transfer nips of the primary transfer rollers 9Y, 9M, 9C, and 9K. Thus, the toner images formed on the respective photoconductor drums 1Y, 1M, 1C, and 1K are primarily transferred onto the intermediate transfer belt 8 while being superimposed one atop another to form a composite color toner image on the intermediate transfer belt 8 (primary transfer process).

Subsequently, the intermediate transfer belt 8 to which the superimposed toner images of yellow, cyan, magenta, and black have been transferred reaches a position opposite a secondary transfer belt 72. At this position, a secondary-transfer backup roller 40 presses against a secondary transfer roller 70 via the intermediate transfer belt 8 and the secondary transfer belt 72 to form a secondary transfer nip. The four-color toner image is secondarily transferred from the intermediate transfer belt 8 onto a sheet P such as a recording medium conveyed to the secondary transfer nip (secondary transfer process). At this time, a small amount of toner may remain untransferred on the intermediate transfer belt 8 as untransferred toner or residual toner.

The intermediate transfer belt 8 reaches a position opposite an intermediate-transfer-belt cleaner 10. At this position, the intermediate-transfer-belt cleaner 10 removes substances such as residual toner adhering to the surface of the intermediate transfer belt 8. Thus, a series of transfer processes performed on the intermediate transfer belt 8 ends.

With reference to FIG. 1, the sheet P is conveyed from a sheet feeder 26 disposed in a lower portion of the body of the image forming apparatus 100 to the secondary transfer nip via, for example, a feed roller 27 and a registration roller pair 28. Specifically, the sheet feeder 26 stores a stack of multiple sheets P such as sheets of paper stacked on one on another. The feed roller 27 is rotated counterclockwise in FIG. 1 to pick up and feed an uppermost sheet P of the plurality of sheets P toward between rollers of the registration roller pair 28 via a first conveyance passage K1.

The sheet P conveyed to the registration roller pair 28 (timing roller pair) temporarily stops at a position of the roller nip between the rollers of the registration roller pair 28 that has stopped rotating. The registration roller pair 28 is rotated at a timing at which the sheet P meets the color toner image on the intermediate transfer belt 8 at the secondary transfer nip, to convey the sheet P toward the secondary transfer nip. Thus, the desired color image is transferred onto the sheet P.

The sheet P, onto which the multicolor toner image is transferred at the secondary transfer nip, is conveyed on the secondary transfer belt 72 and separated from the secondary transfer belt 72, and then a conveying belt 60 conveys the sheet P to a fixing device 50. In the fixing device 50, the color toner image is fixed onto the sheet P under heat and pressure from a fixing belt and a pressure roller (fixing process). The sheet P is conveyed through a second conveyance passage K2 and ejected by an output roller pair to the outside of the image forming apparatus 100. The sheets P ejected by the output roller pair to the outside of the image forming apparatus 100 are sequentially stacked as output images on a stack tray. Thus, a series of image forming processes (printing operation) in the image forming apparatus 100 is completed.

When the “duplex printing mode” in which images are printed on both sides (front side and back side) of the sheet P is selected, the sheet P after the fixing process on the front side is guided to a third conveyance passage K3 without being ejected from the third conveyance path K3 as it is as in the case where above-described “single-sided printing mode” is selected, and the conveyance direction of the sheet P is reversed, the sheet P is conveyed toward the position of the secondary transfer nip (secondary-transfer-belt device 69) again via a fourth conveyance passage K4. An image is formed on the back side of the sheet P by the same image forming process (image forming operation) as described above at the position of the secondary transfer nip. Then, the sheet P is subjected to the fixing step in the fixing device 50, is ejected from the body of the image forming apparatus 100 via the second conveyance passage K2.

A detailed description is given of a configuration and operation of the developing device 5Y of the image forming device 6Y with reference to FIG. 2. The developing device 5Y includes a developing roller 51Y opposite the photoconductor drum 1Y, a doctor blade 52Y opposite the developing roller 51Y, two screw conveyors 55Y disposed in a developer storage of the developing device 5Y, and a toner concentration sensor 56Y to detect a toner concentration in developer G. The developing roller 51Y includes a magnet and a sleeve. The magnet is fixed inside the developing roller 51Y. The sleeve rotates around the magnet. The developer storage contains the developer G, which is a two-component developer including carrier and toner.

The developing device 5Y having a configuration as described above operates as follows. The sleeve of the developing roller 51Y rotates in the direction indicated by an arrow in FIG. 2. The developer G is carried on the developing roller 51Y by a magnetic field generated by the magnet. As the sleeve rotates, the developer G moves along the outer circumferential surface of the developing roller 51Y. The ratio of toner to carrier (i.e., toner concentration) in the developer G contained in the developing device 5Y is adjusted within a specified range. Specifically, when low toner concentration is detected by a toner concentration sensor disposed in the developing device 5Y, fresh toner is supplied from a toner container 58 to the developing device 5Y to keep the toner concentration within the specified range. The two screw conveyors 55Y stir and mix the developer G with the toner supplied from the toner container 58 to the developer storage while circulating the developer G in the developer storage separated into two compartments. In this case, the developer G moves in the direction perpendicular to the plane on which FIG. 2 is illustrated. The toner in the developer G is electrically charged by friction with the carrier, so that the toner is attracted to the carrier. Both the toner and the carrier are borne on the developing roller 51Y due to a magnetic force generated on the developing roller 51Y.

The developer G borne on the developing roller 51Y is conveyed in the direction indicated by the arrow in FIG. 2 and reaches a position opposite the doctor blade 52Y. At this position, the doctor blade 52Y adjusts the amount of the developer G on the developing roller 51Y to an appropriate amount. Thereafter, the developer G on the developing roller 51Y is conveyed to a position opposite the photoconductor drum 1Y (which is a development area). The toner is attracted to the electrostatic latent image formed on the photoconductor drum 1Y by an electric field generated in the development area. As the sleeve rotates, the developer G remaining on the developing roller 51Y reaches an upper part of the developer housing and separates from the developing roller 51Y. The toner container 58 is detachably (i.e., replaceably) attached on the developing device 5Y (the image forming apparatus 100). When the fresh toner contained in the toner container 58 is consumed and the toner container 58 becomes empty, the toner container 58 is detached from the developing device 5Y (the image forming apparatus 100) and replaced with a new one.

Next, a detail description is given of the intermediate-transfer-belt device 15 as a belt device. With reference to FIG. 3, the intermediate-transfer-belt device 15 (the belt device) includes the intermediate transfer belt 8 as a belt, the four primary transfer rollers 9Y, 9M, 9C, and 9K, the drive roller 16, a correction roller 17 (driven roller), a pre-transfer roller 18, a tension roller 19, the intermediate-transfer-belt cleaner 10, and the secondary-transfer backup roller 40. The intermediate transfer belt 8 contacts the four photoconductor drums 1Y, 1M, 1C, and 1K, which bear the toner images of the respective colors, to form the primary transfer nips. The intermediate transfer belt 8 is stretched around and supported by five rollers, which are the drive roller 16, the correction roller 17, the pre-transfer roller 18, the tension roller 19, and the secondary-transfer backup roller 40.

According to the present embodiment, the intermediate transfer belt 8 includes a single layer or multiple layers including, but not limited to, polyvinylidene fluoride (PVDF), ethylene-tetrafluoroethylene copolymer (ETFE), polyimide (PI), polycarbonate (PC), polyamide imide (PAI), thermoplastic elastomer (TPE), or polyether ether ketone (PEEK) with a conductive material such as carbon black dispersed therein. The intermediate transfer belt 8 is adjusted to have a volume resistivity in a range of 10⁶ to 10¹³ Ω·cm and an inner circumferential surface resistivity in a range of 10⁷ to 10¹³ Ω·cm. The intermediate transfer belt 8 has a thickness in a range of 20 to 200 μm. In the present embodiment, the intermediate transfer belt 8 has a thickness of about 60 μm and a volume resistivity of about 10⁹ Ω·cm. The intermediate transfer belt 8 may have a release layer coated on the surface of the intermediate transfer belt 8 as needed. In this case, a fluorine resin such as ETFE, polytetrafluoroethylene (PTFE), PVDF, perfluoroalkoxy fluorine resin (PEA), tetrafluoroethylene-hexafluoropropylene copolymer (FEP), or vinyl fluoride (PVF) may be used as a material for the coating. Note that the material for the coating is not limited to the fluorine resin.

The primary transfer rollers 9Y, 9M, 9C, and 9K contact the photoconductor drums 1Y, 1M, 1C, and 1K, respectively, via the intermediate transfer belt 8. Specifically, the primary transfer roller 9Y for yellow contacts the photoconductor drum 1Y for yellow via the intermediate transfer belt 8. The primary transfer roller 9M for magenta contacts the photoconductor drum 1M for magenta via the intermediate transfer belt 8. The primary transfer roller 9C for cyan contacts the photoconductor drum 1C for cyan via the intermediate transfer belt 8. The primary transfer roller 9K for black contacts the photoconductor drum 1K for black via the intermediate transfer belt 8. Each of the primary transfer rollers 9Y, 9M, 9C, and 9K is an elastic roller in which a conductive sponge layer is formed on a core metal, and is adjusted to have a volume resistance in a range of 10⁶ to 10¹² Ω·cm (preferably, 10⁷ to 10⁹ Ω·cm).

The drive roller 16 is disposed to contact an inner circumferential surface of the intermediate transfer belt 8 by an angle of belt winding of about 120 degrees at a position downstream from the four photoconductor drums 1Y, 1M, 1C, and 1K in a direction of rotation of the intermediate transfer belt 8. The drive roller 16 is rotated clockwise in FIG. 3 by the drive motor Mt1, which is controlled by a controller 90. With such a configuration, the intermediate transfer belt 8 rotates in a specified direction (i.e., clockwise in FIG. 3).

The correction roller 17 is disposed in contact with the inner circumferential face of the intermediate transfer belt 8 by the angle of belt winding of about 180 degrees at a position upstream from the four photoconductor drums 1Y, 1M, 1C, and 1K in the direction of rotation (travel direction) of the intermediate transfer belt 8. A portion of the intermediate transfer belt 8 extending from the correction roller 17 to the drive roller 16 via the four photoconductor drums 1Y, 1M, 1C, and 1K is substantially horizontal. The correction roller 17 is rotated clockwise in FIG. 3 as the intermediate transfer belt 8 rotates. A detailed description is given below of the correction roller 17 for correcting the deviation of the belt (movement of the belt in the width direction) of the intermediate transfer belt 8.

The intermediate-transfer-belt cleaner 10 is disposed at the position of the correction roller 17. The intermediate-transfer-belt cleaner 10 includes a cleaning blade 85 to contact the correction roller 17 via the intermediate transfer belt 8. The cleaning blade 85 contacts the intermediate transfer belt 8 at a specified contact angle and a specified contact pressure. The tension roller 19 contacts the outer circumferential surface of the intermediate transfer belt 8. The pre-transfer roller 18 and the secondary-transfer backup roller 40 contact the inner circumferential surface of the intermediate transfer belt 8. The rollers 17, 18, 19, and 40 except the drive roller 16 are rotated clockwise in FIG. 3 by the rotation of the intermediate transfer belt 8.

With reference to FIG. 3, the secondary-transfer backup roller 40 contacts the secondary transfer roller 70 via the intermediate transfer belt 8 and the secondary transfer belt 72. The secondary-transfer backup roller 40 includes a cylindrical core made of, for example, stainless steel, having an elastic layer on the outer circumferential face of the core. The elastic layer is made of acrylonitrile-butadiene rubber (NBR). The elastic layer has a volume resistivity ranging from approximately 10⁷ to 108 Ω·cm, and a hardness ranging from approximately 48 to 58 degrees on Japanese Industrial Standards A hardness (JIS-A hardness) scale. The elastic layer has a thickness of approximately 5 mm.

According to the present embodiment, the secondary-transfer backup roller 40 is electrically connected to a power supply 91, which applies a high voltage of approximately-5 kV as a secondary transfer bias to the secondary-transfer backup roller 40. With the secondary transfer bias applied to the secondary-transfer backup roller 40, the toner image primarily transferred to the surface of the intermediate transfer belt 8 is secondarily transferred onto the sheet P conveyed to the secondary transfer nip. The secondary transfer bias has the same polarity as the polarity of toner. In the present embodiment, the secondary transfer bias is a direct current voltage in a negative polarity. Accordingly, a secondary-transfer electric field electrostatically moves the toner borne on a toner bearing surface (i.e., the outer circumferential surface) of the intermediate transfer belt 8 in a direction from the secondary-transfer backup roller 40 to the secondary-transfer-belt device 69.

The secondary-transfer-belt device 69 includes the secondary transfer belt 72, the secondary transfer roller 70, a driven roller 71, and a secondary transfer blade 73 (cleaning blade). As the secondary transfer roller 70 is rotated counterclockwise in FIG. 3 by a motor Mt2 controlled by the controller 90, the secondary transfer belt 72 is rotated counterclockwise in FIG. 3, and thus, the driven roller 71 is rotated counterclockwise in FIG. 3 by the rotation of the secondary transfer belt 72. In other words, the secondary transfer roller 70 functions as a drive roller that drives the secondary transfer belt 72 as a belt. The driven roller 71 is disposed at a position downstream from the secondary transfer nip in a conveyance direction (i.e., downstream from the secondary transfer nip in the conveyance direction of the sheet P). The sheet P ejected from the secondary transfer nip is conveyed along the secondary transfer belt 72 rotating counterclockwise in FIG. 3, and then, separated (a curvature separation) from the secondary transfer belt 72 at a position of the driven roller 71 by the secondary transfer belt 72 on which a curved surface is formed to be along an outer circumference of the driven roller 71. In this way, the driven roller 71 also functions as a separation roller. The secondary transfer blade 73 contacts the surface of the secondary transfer belt 72 to remove substances such as toner and paper dust adhering to the surface of the secondary transfer belt 72.

A detailed description is given below of a configuration and an operation of the intermediate-transfer-belt device 15 as a belt device. With reference to FIGS. 4, 6A, 6B, and 8, the intermediate-transfer-belt device 15 (belt device) includes the intermediate transfer belt 8 (belt) stretched and supported by the plurality of rollers 9Y, 9M, 9C, 9K, 16, 17, 18, 19, and 40, and a correction mechanism 79 that inclines one roller (correction roller 17) of the plurality of rollers with respect to the width direction (in the rotation axis direction). The correction mechanism 79 inclines the correction roller 17 in conjunction with the operation of the intermediate transfer belt 8 moving in the width direction, to correct the belt deviation of the intermediate transfer belt 8.

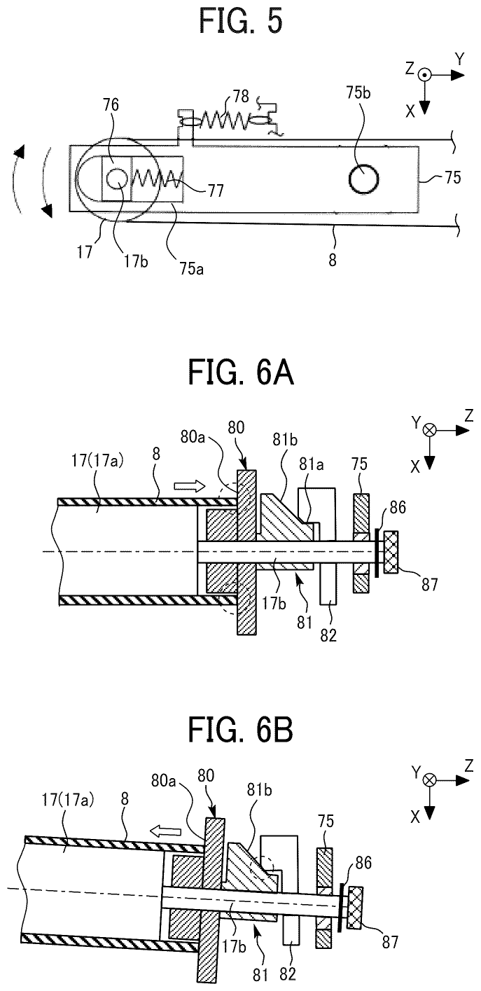

Specifically, as illustrated in FIG. 4, the correction roller 17 (one of the plurality of rollers) includes a roller portion 17a that contacts the inner circumferential surface of the intermediate transfer belt 8, and a shaft 17b (roller shaft) that is smaller in outer diameter than the roller portion 17a and protrudes from each of the ends of the roller portion 17a. The shaft 17b may be formed such that two shaft portions protrude separately from both ends of the roller portion 17a, or may be formed such that a single shaft is inserted through the roller portion 17a to protrude from both ends of the roller portion 17a. In any case, the correction roller 17 includes the roller portion 17a and the shaft 17b united with each other, and rotates as one unit. As illustrated in FIG. 4, the intermediate-transfer-belt device 15 includes bearings 76 that receives the shaft 17b of the correction roller 17. The shaft 17b of the correction roller 17 is rotatably held by swinging side plates 75 (see FIG. 5) as holders via the bearings 76 at both ends of the correction roller 17. The correction roller 17 may be formed such that ball bearings are press-fitted to the shaft 17b of the correction roller 17 and the ball bearings are rotatably held by the swinging side plates 75 via bearings (e.g., resin-made sliding bearings).

On the other hand, with reference to FIG. 8, the shafts at both ends of the other rollers such as the drive roller 16 are rotatably held by a housing 74 of the intermediate-transfer-belt device 15 via bearings. The swinging side plate 75 is held by the housing 74 to be rotatable in directions indicated by arrows in FIG. 5 around a support shaft 75b together with the correction roller 17. The swinging side plate 75 is formed to be biased in the clockwise direction in FIG. 5 by a tension spring 78 (biasing member) coupled between the swinging side plate 75 and the housing 74. The shaft 17b of the correction roller 17 is rotatably held in a guide hole 75a of the swinging side plate 75 at each of the ends via the bearing 76. The bearing 76 is slidably held in the guide hole 75a and is urged leftward in FIG. 5 by a compression spring 77. With such a configuration, the correction roller 17 presses against the inner circumferential surface of the intermediate transfer belt 8 by the biasing force of the compression spring 77 and applies tension to the intermediate transfer belt 8.

As illustrated in FIGS. 4, 6A, and 6B, the correction mechanism 79 includes a flange 80 (abutting member), a sliding member 81 (guided portion), and a contact member 82 (guide portion). The sliding member 81 is slidably supported by the shaft 17b of the correction roller 17 (one roller), and inclines the correction roller 17 (shaft 17b) in conjunction with the operation (belt deviation) in which the intermediate transfer belt 8 moves in the width direction (the left-and-right direction in FIGS. 4, 6A, and 6B). The sliding member 81 has a parallel surface 81a parallel to the rotation axis direction and an inclined surface 81b inclined with respect to the parallel surface 81a. The contact member 82 contacts the parallel surface 81a and the inclined surface 81b. The sliding member 81 does not rotate with the traveling of the intermediate transfer belt 8 and the rotation of the correction roller 17 (shaft 17b). Specifically, the sliding member 81 is locked by a projection for rotation stop formed on the housing 74 of the image forming apparatus 100, and thus the rotation of the sliding member 81 is restricted. In the case where the ball bearing is press-fitted to the shaft 17b of the correction roller 17 and the ball bearing is rotatably held by the swinging side plate 75 via the bearing (e.g., resin-made sliding bearing), a projection for preventing rotation may be formed on the bearing.

The contact member 82 is formed to be contactable against the parallel surface 81a and the inclined surface 81b of the sliding member 81. The inclined surface 81b of the sliding member 81 and the contact member 82 slide in conjunction with the operation of the intermediate transfer belt 8 moving in the width direction, thereby inclining the correction roller 17 (shaft 17b). The flange 80 is disposed to be contactable against an end surface of the intermediate transfer belt 8, and is moved by being pushed by the intermediate transfer belt 8 in accordance with the movement of the intermediate transfer belt 8 in the width direction. The flange 80 is formed to be rotatable (co-rotatable) with the traveling of the intermediate transfer belt 8 and the rotation of the correction roller 17 (shaft 17b). The sliding member 81 is disposed to be contactable against the flange 80 at a position opposite the position of the intermediate transfer belt 8.

Further, a supplemental description is given of the correction mechanism 79. The flange 80 is slidably and rotatably held by the shaft 17b of the correction roller 17. The flange 80 has an abutting portion 80a against which an end surface of the intermediate transfer belt 8 abuts when the intermediate transfer belt 8 is shifted. The abutting portion 80a has an outer diameter sufficiently larger than the outer diameter of the correction roller 17 (roller portion 17a) so that the intermediate transfer belt 8 does not ride on the abutting portion 80a. The flange 80 is rotated by the rotation of the correction roller 17. The sliding member 81 is slidably and non-rotatably disposed on the shaft 17b of the correction roller 17 at a position outside the flange 80 in the width direction. The sliding member 81 has the parallel surface 81a and the inclined surface 81b. The sliding member 81 does not rotate even when the correction roller 17 rotates. The contact member 82 is non-rotatably disposed at a fixed position on the shaft 17b to face the sliding member 81.

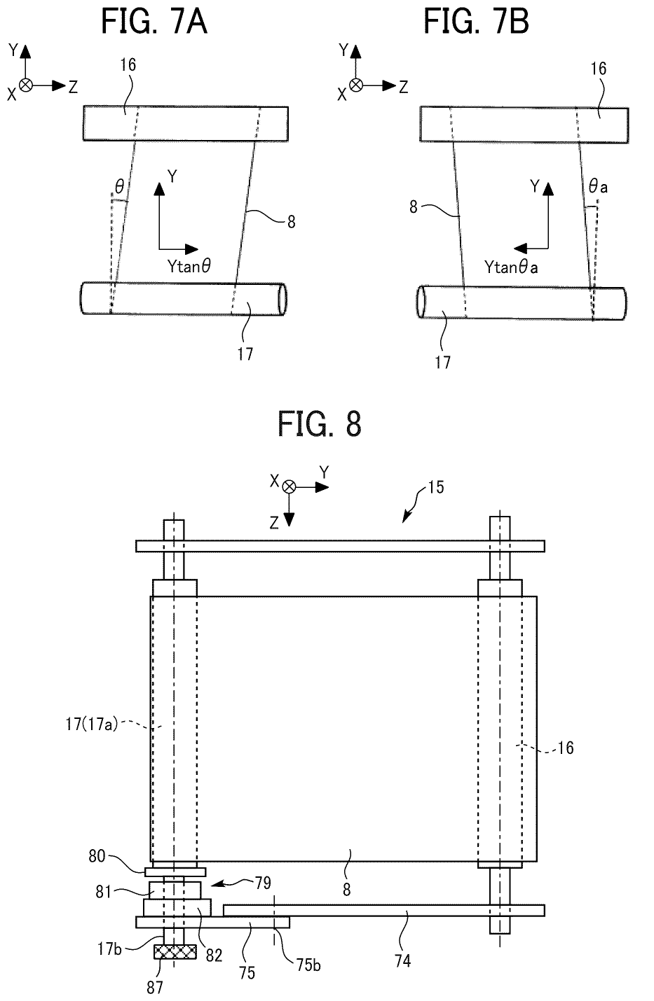

The correction mechanism 79 having such a configuration corrects the belt deviation of the intermediate transfer belt 8 (belt movement in the left-and-right direction in FIGS. 4, 6A, and 6B). A description is given of the basic mechanism of the correction mechanism 79. As illustrated in FIG. 7A, it is assumed that the parallelism between the drive roller 16 and the correction roller 17 is deviated. In FIG. 7A, the right end of the correction roller 17 is inclined in the −X direction (toward the front in the direction perpendicular to the plane on which FIG. 7A is illustrated) with respect to the drive roller 16. In such a case, the intermediate transfer belt 8 is inclined to the right at an inclination angle θ as viewed from the correction roller 17, and when the intermediate transfer belt 8 travels by a distance Y, the intermediate transfer belt 8 is shifted to the right by Y tan θ. When the intermediate transfer belt 8 is shifted to the right, as illustrated in FIG. 6A, the end surface of the intermediate transfer belt 8 contacts the abutting portion 80a of the flange 80, and the flange 80 slides to the right to push the sliding member 81 to the right. When the sliding member 81 is pushed to the right, the contact member 82, which has been in contact with the parallel surface 81a as illustrated in FIG. 6A, contacts the inclined surface 81b as illustrated in FIG. 6B, and the correction roller 17 is inclined along the inclination of the inclined surface 81b as illustrated in FIGS. 6B and 7B. As illustrated in FIG. 7B (and FIG. 6B), when the right end of the correction roller 17 is inclined in the +X direction (the depth direction perpendicular to the plane on which FIG. 7B (and FIG. 6B) is illustrated), the intermediate transfer belt 8 is inclined to the left at an inclination angle θa as viewed from the correction roller 17. When the intermediate transfer belt 8 travels by a distance Y, the intermediate transfer belt 8 is shifted to the left by Y tan θa, and thus, the deviation of the intermediate transfer belt 8 in the right direction is offset. In this way, the deviation of the intermediate transfer belt 8 is corrected by the correction mechanism 79.

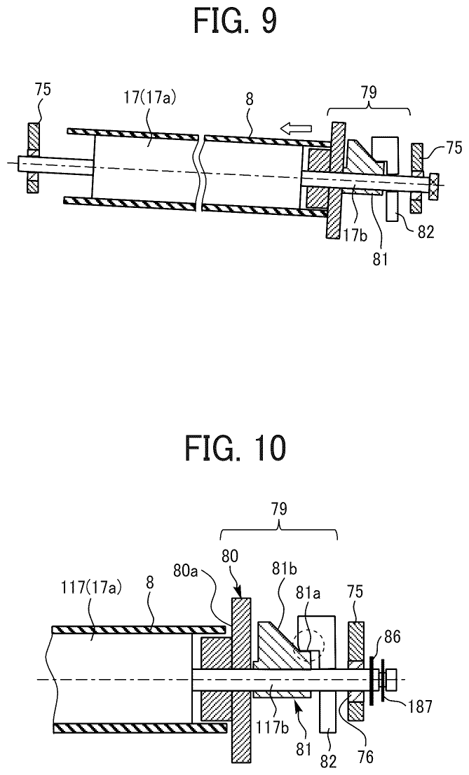

The correction mechanism 79 having such a configuration can prevent occurrence of the deviation of the intermediate transfer belt 8. In particular, the correction roller 17 (shaft 17b) can be inclined by a simple and space-saving configuration in which the contact member 82 is only slid relative to the inclined surface 81b of the sliding member 81. The flange 80, which has a configuration and operates as described above, is disposed between the intermediate transfer belt 8 and the sliding member 81, and thus, the force by which the intermediate transfer belt 8 is shifted in the width direction can be directly transmitted to the sliding member 81 by the flange 80, so that the stable belt deviation correction can be performed. In the present embodiment, the flange 80 is rotatable in conjunction with the intermediate transfer belt 8, and the intermediate transfer belt 8 and the flange 80 do not rub against each other. Thus, an inconvenience of abrasion of the end surface of the intermediate transfer belt 8 can be reduced. The sliding member 81 does not rotate, so that the inclined surface 81b and the parallel surface 81a may not be formed over the rotation direction. Thus, an inconvenience in which the sliding member 81 is enlarged in size can be prevented. Although not illustrated in FIGS. 8 and 9, in the present embodiment, the correction mechanism 79 is disposed not only on one end of the correction roller 17 in the width direction (lower side in FIG. 8) but also on another end of the correction roller 17 in the width direction (upper side in FIG. 8).

A detailed description is given below of a configuration and an operation of the intermediate-transfer-belt device 15 as a belt device. As described above with reference to FIG. 4, the intermediate-transfer-belt device 15 (belt device) in the present embodiment includes the correction mechanism 79 that inclines one roller (correction roller 17) of the plurality of rollers that stretch and support the intermediate transfer belt 8 (belt), in conjunction with the operation of moving of the intermediate transfer belt 8 (belt) in the width direction (left-and-right direction in FIG. 4). The intermediate-transfer-belt device 15 includes the swinging side plate 75 as a holder that rotatably holds the shaft 17b of the correction roller 17 (one roller).

With reference to FIG. 4, in the intermediate-transfer-belt device 15 according to the present embodiment includes a screw 87 as a restricting member that restricts the movement of the correction roller 17 (one roller) in the width direction. The screw 87 is disposed on the shaft 17b of the correction roller 17 to be indirectly (or directly) contactable with the swinging side plate 75 on the outer side (right side in FIG. 4) of the swinging side plate 75 (holder) in the width direction. The screw 87 as the restricting member is fixed to the shaft 17b such that the screw 87 is united with the correction roller 17 (one roller) to be rotatable with the correction roller 17 together.

Specifically, as illustrated in FIG. 4, an intermediate member 86 having a substantially doughnut shape is disposed between the swinging side plate 75 (holder) and the screw 87 (restricting member) on the shaft 17b of the correction roller 17. At least the surface of the intermediate member 86 is formed of a low-friction material (e.g., a fluorine resin material). In other words, the screw 87 as the restricting member is disposed to be indirectly contactable with the swinging side plate 75 via the intermediate member 86. The screw 87 as the restricting member is formed of a metallic material which is less likely to be worn and deteriorated. The male screw portion of the screw 87 is screwed into a screw hole 17b1 (formed inside from the end surface of the shaft 17b).

The screw 87 (screw head) as the restricting member is formed such that an outer diameter of the screw 87 is larger than a shaft diameter of the shaft 17b (or an inner diameter of the bearing 76) and is larger than an inner diameter of the intermediate members 86. With such a configuration, even when the screw 87 rotates together with the correction roller 17 (shaft 17b), the screw 87 does not slide over and contact the swinging side plate 75 but slides over and contacts the intermediate member 86 made of a low-friction material. Thus, an inconvenience that the screw 87 wears is less likely to occur. The screw diameter of the screw 87 is larger than the shaft diameter of the shaft 17b. Even when the correction roller 17 (shaft 17b) moves to the left in FIG. 4, the screw 87 contacts the swinging side plate 75 via the intermediate member 86, and thus, the movement of the screw 87 is restricted (the screw 87 functions as a restricting member).

As described above, in the present embodiment, the screw 87 as the restricting member is fixed to the shaft 17b such that the screw 87 is united with the correction roller 17 to be rotatable with the correction roller 17 together. Thus, the screw 87 (restricting member) is prevented from being rotated by the rotation of the correction roller 17, and the screw 87 and the correction roller 17 are prevented from being worn. Accordingly, an inconvenience that the function of correcting the belt deviation of the intermediate transfer belt 8 is not easily exerted due to the wear of the screw 87 (restricting member) and the correction roller 17 is also prevented. For example, in the case of a correction roller 117 illustrated in FIG. 10 as a comparative example, an E-ring 187 (snap ring) is disposed in a groove formed on a shaft 117b to restrict the movement of the correction roller 117 in the width direction. In such a case, the friction between the correction roller 117 (groove in the shaft 117b) and the E-ring 187 increases over time when the shifting force of the intermediate transfer belt 8 becomes stronger regardless of the presence of the intermediate member 86. As a result, the E-ring 187 does not rotate together with the correction roller 117, and the wear (abrasion) of the E-ring 187 and the correction roller 117 may occur due to sliding. When the wear (abrasion) between the E-ring 187 and the correction roller 117 worsens in this way, the correction roller 117 is shifted in the width direction beyond expectation. Accordingly, the correction roller 117 presses the flange 80 on the opposite side, and then the flange 80 further presses the sliding member 81. As a result, the sliding member 81 on the opposite side abuts against the contact member 82, and the correction roller 117 is inclined. When the correction roller 117 is inclined in this way, the correction roller 117 is inclined to the side where the belt deviation is accelerated, so that the balance of the belt deviation control by the correction mechanism 79 is lost. As a result, a load is applied to the intermediate transfer belt 8, so that an inconvenience such as breakage may occur. On the other hand, in the present embodiment, the screw 87 as the restricting member is fixed to the shaft 17b such that the screw 87 is united with the correction roller 17 to be rotatable with the correction roller 17 together. Accordingly, the wear (abrasion) between the correction roller 17 and the screw 87 (restricting member) is restricted, so that the belt deviation control by the correction mechanism 79 is stably maintained over a long period of time.

In the present embodiment, the intermediate member 86 made of a low friction material is disposed between the swinging side plate 75 and the screw 87 (restricting member). However, at least the surface (the surface that contacts the swinging side plate 75) of the screw 87 (restricting member) may be made of a low friction material without disposing such an intermediate member 86. In this case, the screw 87 as the restricting member is disposed to be directly contactable with the swinging side plate 75. However, the surface of the screw 87 is formed of a low friction material, and thus an inconvenience that the screw 87 wears is unlikely to occur.

In the present embodiment, the screw 87 (restricting member) is detachably attached to the shaft 17b. Specifically, the screw 87 is screwed to and unscrewed from the screw hole 17b1 of the shaft 17b so that the screw 87 can be easily attached to and detached from the shaft 17b. The screw 87 (restricting member) is formed to be detachably attached in this way, thus allowing the maintenance and replacement of the screw 87 (restricting member) to be easily performed.

### First Modification

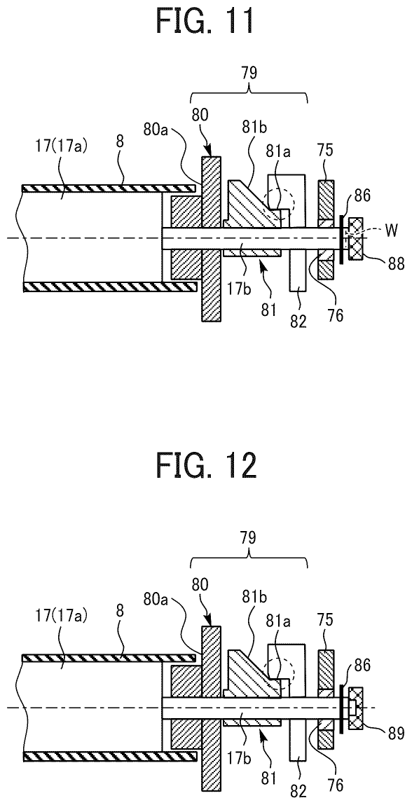

As illustrated in FIG. 11, in the intermediate-transfer-belt device 15 (belt device) according to a first modification, a restricting member 88 is bonded or welded to an end (an end surface W) of the shaft 17b of the correction roller 17. The restricting member 88 has a substantially disc shape and is made of a metallic material. The outer diameter of the restricting member 88 is larger than the shaft diameter of the shaft 17b (or the inner diameter of the bearing 76) and larger than the inner diameter of the intermediate member 86. Even when such a restricting member 88 is used, the restricting member 88 that restricts the movement of the correction roller 17 (roller) in the width direction, which is inclined by the correction mechanism 79, and the correction roller 17 are less likely to be worn. In the first modification, the restricting member 88 may be fixed to the end of the shaft 17b by caulking.

### Second Modification

As illustrated in FIG. 12, in the intermediate-transfer-belt device 15 according to a second modification, a cap 89 as a restricting member is press-fitted into an end of the shaft 17b of the correction roller 17. The cap 89 is made of a metallic material and has a recess that can be press-fitted (fixed) to the shaft 17b. The outer diameter of the cap 89 is larger than the shaft diameter of the shaft 17b (or the inner diameter of the bearing 76) and larger than the inner diameter of the intermediate member 86. Even when such a cap 89 is used, the restricting member 88 that restricts the movement of the correction roller 17 (roller) in the width direction, which is inclined by the correction mechanism 79, and the correction roller 17 are less likely to be worn.

As described above, the intermediate-transfer-belt device 15 (belt device) according to the present embodiment includes the intermediate transfer belt 8 (belt), the correction mechanism 79, and the swinging side plate 75. The intermediate transfer belt 8 is stretched and supported by the plurality of rollers. The correction mechanism 79 inclines the correction roller 17 (one roller) among the plurality of rollers in conjunction with the operation of the intermediate transfer belt 8 moving in the width direction. The swinging side plate 75 (holding member) holds the shaft 17b of the correction roller 17 to be rotatable. The screw 87 (restricting member) that restricts the movement of the correction roller 17 in the width direction is disposed on the shaft 17b at the outer side of the swinging side plate 75 in the width direction to be directly or indirectly contactable with the swinging side plate 75. The screw 87 is fixed to the shaft 17b such that the screw 87 is united with the correction roller 17 to be rotatable with the correction roller 17 together. With such a configuration, the screw 87 (restricting member) that restricts the movement of the correction roller 17 (roller) in the width direction, which is inclined by the correction mechanism 79, and the correction roller 17 are unlikely to be worn.

In the present embodiment, the present disclosure is applied to the intermediate-transfer-belt device 15 that corrects the belt deviation of the intermediate transfer belt 8 as the belt. However, the present disclosure is not limited to this. For example, the present disclosure can be applied to not only the secondary-transfer-belt device 69 in which the secondary transfer belt 72 is installed in the present embodiment, but also a belt device in which a belt such as a photoconductor belt, a transfer conveying belt, or a fixing belt is installed. Further, in the above-described embodiments, the present disclosure is applied to the image forming apparatus 100 that forms color image. Alternatively, the present disclosure may also be applied to an image forming apparatus that forms a monochrome image alone. Even in such a case, advantageous effects equivalent to the effects of the above-described embodiments can be obtained.

Note that embodiments of the present disclosure are not limited to the above-described embodiments and it is apparent that the above-described embodiments can be appropriately modified within the scope of the technical idea of the present disclosure in addition to what is suggested in the above-described embodiments. Further, features of components of the embodiments, such as the number, the position, and the shape are not limited the embodiments and thus may be preferably set.

Aspects of the present disclosure may be, for example, a combination of the first to fourteenth aspects as follows.

### First Aspect

A belt device (e.g., the intermediate-transfer-belt device 15) includes a belt (e.g., the intermediate transfer belt 8), a correction mechanism (e.g., the correction mechanism 79), a holder (e.g., the swinging side plate 75), and a restricting member (e.g., the restricting member 88). The belt is stretched and supported by a plurality of rollers. The correction mechanism inclines one roller of the plurality of rollers in conjunction with movement of the belt in a width direction of the belt. The holder rotatably holds a shaft (e.g., the shaft 17b) of the one roller. The restricting member is disposed on the shaft outside the holder in the width direction to be indirectly or directly contactable with the holder and restricts movement of the one roller in the width direction. The restricting member is fixed to the shaft and united with the one roller to be rotatable with the one roller together.

### Second Aspect

The belt device (e.g., the intermediate-transfer-belt device 15) according to the first aspect further includes an intermediate member (e.g., the intermediate member 86). At least a surface of the intermediate member is formed of a low friction material. The intermediate member is disposed between the holder (e.g., the swinging side plate 75) and the restricting member (e.g., the restricting member 88) on the shaft (e.g., the shaft 17b).

### Third Aspect

In the belt device (e.g., the intermediate-transfer-belt device 15) according to the second aspect, an outer diameter of the restricting member (e.g., the restricting member 88) is greater than an inner diameter of the intermediate member (e.g., the intermediate member 86).

### Fourth Aspect

In the belt device (e.g., the intermediate-transfer-belt device 15) according to any one of the first to third aspects, at least a surface of the restricting member (e.g., the restricting member 88) is formed of a low friction material.

### Fifth Aspect

In the belt device (e.g., the intermediate-transfer-belt device 15) according to any one of the first to fourth aspects, the restricting member (e.g., the screw 87) is detachably attached to the shaft (e.g., the shaft 17b).

### Sixth Aspect

In the belt device (e.g., the intermediate-transfer-belt device 15) according to any one of the first to fifth aspects, the restricting member (e.g., the screw 87) is a screw screwed into a screw hole formed on an end surface of the shaft (e.g., the shaft 17b).

### Seventh Aspect

In the belt device (e.g., the intermediate-transfer-belt device 15) according to any one of the first to fourth aspects, the restricting member (e.g., the screw 87) is press-fitted to an end of the shaft (e.g., the shaft 17b).

### Eighth Aspect

In the belt device (e.g., the intermediate-transfer-belt device 15) according to any one of the first to fourth aspects, the restricting member (e.g., the screw 87) is bonded or welded to an end of the shaft (e.g., the shaft 17b).

### Ninth Aspect

In the belt device (e.g., the intermediate-transfer-belt device 15) according to any one of the first to fourth aspects, the restricting member (e.g., the screw 87) is caulked to an end of the shaft (e.g., the shaft 17b).

### Tenth Aspect

In the belt device (e.g., the intermediate-transfer-belt device 15) according to any one of the first to ninth aspects, the restricting member (e.g., the screw 87) is formed of a metal material.

### Eleventh Aspect

In the belt device (e.g., the intermediate-transfer-belt device 15) according to any one of the first to tenth aspects, the correction mechanism (e.g., the correction mechanism 79) includes a sliding member (e.g., the sliding member 81) and a contact member (e.g., the contact member 82). The sliding member is slidably supported on the shaft of the one roller and has an inclined surface. The contact member is formed to be contactable with the inclined surface of the sliding member. The one roller is inclined by sliding of the inclined surface of the sliding member and the contact member in conjunction with an operation of the movement of the belt (e.g., the intermediate transfer belt 8) in the width direction.

### Twelfth Aspect

The belt device (e.g., the intermediate-transfer-belt device 15) according to the eleventh aspect further includes a flange (e.g., the flange 80) that is disposed to be contactable against an end surface of the belt (e.g., the intermediate transfer belt 8) and is moved by being pushed by the belt in accordance with the movement of the belt in the width direction. The sliding member (e.g., the sliding member 81) is disposed to be contactable against the flange at a position opposite a position of the belt.

### Thirteenth Aspect

In the belt device (e.g., the intermediate-transfer-belt device 15) according to the twelfth aspect, the flange (e.g., the flange 80) is rotatable with a travel of the belt (e.g., the intermediate transfer belt 8), and the sliding member (e.g., the sliding member 81) does not rotate with the travel of the belt.

### Fourteenth Aspect

An image forming apparatus (e.g., the image forming apparatus 100) includes the belt (e.g., the intermediate transfer belt 8) according to any one of the first to thirteenth aspects.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A belt device comprising:
a plurality of rollers;
a belt stretched and supported by the plurality of rollers;
a correction mechanism to incline one roller of the plurality of rollers in conjunction with movement of the belt in a width direction of the belt;
a holder to hold a shaft of the one roller to be rotatable; and
a restricting member disposed on the shaft outside the holder in the width direction to be indirectly or directly contactable with the holder to restrict movement of the one roller in the width direction,
wherein the restricting member is fixed to the shaft and is rotatable with the one roller together.

2. The belt device according to claim 1, further comprising an intermediate member between the holder and the restricting member on the shaft,
wherein at least a surface of the intermediate member is formed of a low friction material.

3. The belt device according to claim 2,
wherein an outer diameter of the restricting member is greater than an inner diameter of the intermediate member.

4. The belt device according to claim 1,
wherein at least a surface of the restricting member is formed of a low friction material.

5. The belt device according to claim 1,
wherein the restricting member is detachably attached to the shaft.

6. The belt device according to claim 1,
wherein the restricting member is a screw screwed into a screw hole on an end surface of the shaft.

7. The belt device according to claim 1,
wherein the restricting member is press-fitted to an end of the shaft.

8. The belt device according to claim 1,
wherein the restricting member is bonded or welded to an end of the shaft.

9. The belt device according to claim 1,
wherein the restricting member is caulked to an end of the shaft.

10. The belt device according to claim 1,
wherein the restricting member is formed of a metal material.

11. The belt device according to claim 1,
wherein the correction mechanism includes:
a sliding member slidably supported by the shaft of the one roller and having an inclined surface; and
a contact member to be contactable with the inclined surface of the sliding member, and
wherein the one roller is inclined by sliding of the inclined surface of the sliding member and the contact member in conjunction with an operation of the movement of the belt in the width direction.

12. The belt device according to claim 11, further comprising a flange disposed to be contactable against an end surface of the belt,
wherein the flange is pushed and moved by the belt in accordance with the movement of the belt in the width direction, and
wherein the sliding member is disposed to be contactable against the flange at a position opposite a position of belt with respect to the flange.

13. The belt device according to claim 12,
wherein the flange is rotatable with a travel of the belt, and
wherein the sliding member is independent of the travel of the belt.

14. An image forming apparatus comprising the belt device according to claim 1.
